(19) United States
(12) Patent Application Publication
(10) Pub. No.: US 2023/0049808 A1
(43) Pub. Date: Feb. 16, 2023

(54) METHOD AND APPARATUS FOR PURCHASING FULFILLMENT VIA A VIRTUAL ASSISTANT

(71) Applicant: AT&T Intellectual Property I, L.P., Atlanta, GA (US)

(72) Inventors: Rashmi Palamadai, Naperville, IL (US); Nigel Bradley, Canton, GA (US); Eric Zavesky, Austin, TX (US)

(73) Assignee: AT&T Intellectual Property I, L.P., Atlanta, GA (US)

(21) Appl. No.: 17/398,697

(22) Filed: Aug. 10, 2021

(51) Int. Cl. G06Q 10/08

(52) U.S. Cl. CPC G06Q 10/087

(57) ABSTRACT

Aspects of the subject disclosure may include, for example, a method including identifying an upcoming event associated with a first member of a group, where the upcoming event is associated with an interest, by a second member of the group, in a purchase of a product associated with the first member of the group, generating a set of weighted characteristics associated with the product according to a first ranking of characteristics associated with the product and the first member and a second ranking of the characteristics associated with the product and the second member, applying the set of weighted characteristics to product offerings for fulfilling the request to purchase the product to generate a plurality of matrix scores associated with the product offerings, determining a ranked list of the product offerings for the fulfilling the request to purchase the product according to the plurality of matrix scores, negotiating, with a retail virtual assistant, a purchase arrangement associated with a first product offering, and executing an automatic purchase of the first product offering according to the purchase arrangement. Other embodiments are disclosed.

### FIELD OF THE DISCLOSURE

The subject disclosure relates to a method and apparatus for purchasing fulfillment via a virtual assistant.

### BACKGROUND

Modern telecommunications systems provide consumers with telephony capabilities while accessing a large variety of content. Consumers are no longer bound to specific locations when communicating with others or when enjoying multimedia content or accessing the varied resources available via the Internet. Network capabilities have expanded and have created additional interconnections and new opportunities for using mobile communication devices in a variety of situations. Intelligent devices offer new means for experiencing network interactions in ways that anticipate consumer desires and provide solutions to problems.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 to provide a virtual assistant-based product purchasing service in accordance with various aspects described herein.

FIG. 2B is a workflow diagram illustrating an example, non-limiting embodiment of a system functioning within the communication network of FIG. 1 to provide a virtual assistant-based product purchasing service in accordance with various aspects described herein.

FIGS. 2C-E depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for providing a virtual assistant-based product purchasing service. A virtual assistant to a group of members can identify a request for purchase of a product on behalf of a first group member. The virtual assistant can determine other group members having an interest in the product purchase. The virtual assistant can determine characteristics of the product and rank those characteristics for the first group member and the interested group members. The virtual assistant can generate a set of weighted characteristics for the product based on the rankings and apply these weights to a set of product offerings to generate matrix scores. The virtual assistant can determine a ranked list of the product offerings based on the matrix scores. The virtual assistant can compare products of the ranked list with an automatic purchase boundary and, if within the boundary, negotiate a purchase arrangement with a retail virtual assistant. If the products are not within the ranked boundary, the virtual assistant can assess available supply chain information regarding the product and notify the group of purchasing opportunities. Other embodiments are described in the subject disclosure.

One or more aspects of the subject disclosure a method performed by a processing system including a processor. The method can include identifying a request for a purchase of a product associated with a first member of a group, where a second member of the group has an interest in the purchase of the product. The method can include determining a second member of the group having an interest in the purchase of the product. The method can also include determining a first ranking of characteristics associated with the product for the first member of the group and a second ranking of the characteristics associated with the product for the second member of the group. The method can further include generating a set of weighted characteristics associated with the product according to the first ranking of the characteristics and the second ranking of the characteristics associated with the product and, in turn, applying the set of weighted characteristics to a plurality of product offerings for fulfilling the request to purchase the product to generate a plurality of matrix scores associated with the plurality of product offerings. The method can include determining a ranked list of the plurality of product offerings for the fulfilling the request to purchase the product according to the plurality of matrix scores associated with the plurality of product offerings. The method can also include determining if a first product offering of the ranked list of the plurality of product offerings falls within an automatic purchase boundary according to a purchasing profile associated with the group. The method can further include negotiating, with a retail virtual assistant, a purchase arrangement associated with the first product offering of the ranked list of the plurality of product offerings responsive to the determining the first product offering falls within the automatic purchase boundary, and, in turn, executing an automatic purchase of the first product offering of the ranked list of the plurality of product offerings according to the purchase arrangement.

One or more aspects of the subject disclosure include a device, including a processing system including a processor and a memory that stores executable instructions that, when executed by the processing system, facilitate performance of operations. The operations can include identifying a request for a purchase of a product associated with a first member of a group, and, in turn, determining a second member of the group having an interest in the purchase of the product. The operations can also include determining a first ranking of characteristics associated with the product for the first member of the group and a second ranking of the characteristics associated with the product for the second member of the group. The operations can further include generating a set of weighted characteristics associated with the product according to the first ranking of the characteristics and the second ranking of the characteristics associated with the product, and, in turn, applying the set of weighted characteristics to a plurality of product offerings for fulfilling the request to purchase the product to generate a plurality of matrix scores associated with the plurality of product offerings. The operations can include determining a ranked list of the plurality of product offerings for the fulfilling the request to purchase the product according to the plurality of matrix scores associated with the plurality of product offerings. The operations can further include negotiating, with a retail virtual assistant, a purchase arrangement associated with a first product offering of the ranked list of the plurality of product offerings and, in turn, executing the purchase arrangement of the first product offering of the ranked list of the plurality of product offerings.

One or more aspects of the subject disclosure include a non-transitory machine-readable medium, comprising executable instructions that, when executed by a processing system including a processor, facilitate performance of operations. The operations can include identifying an upcoming event associated with a first member of a group, wherein the upcoming event is associated with an interest, by a second member of the group, in a purchase of a product associated with the first member of the group. The operations can include generating a set of weighted characteristics associated with the product according to a first ranking of characteristics associated with the product and the first member and a second ranking of the characteristics associated with the product and the second member. The operations can further include applying the set of weighted characteristics to a plurality of product offerings for fulfilling the request to purchase the product to generate a plurality of matrix scores associated with the plurality of product offerings. The operations can include determining a ranked list of the plurality of product offerings for the fulfilling the request to purchase the product according to the plurality of matrix scores associated with the plurality of product offerings. The operations can also include negotiating, with a retail virtual assistant, a purchase arrangement associated with a first product offering of the ranked list of the plurality of product offerings and, in turn, executing an automatic purchase of the first product offering of the ranked list of the plurality of product offerings according to the purchase arrangement.

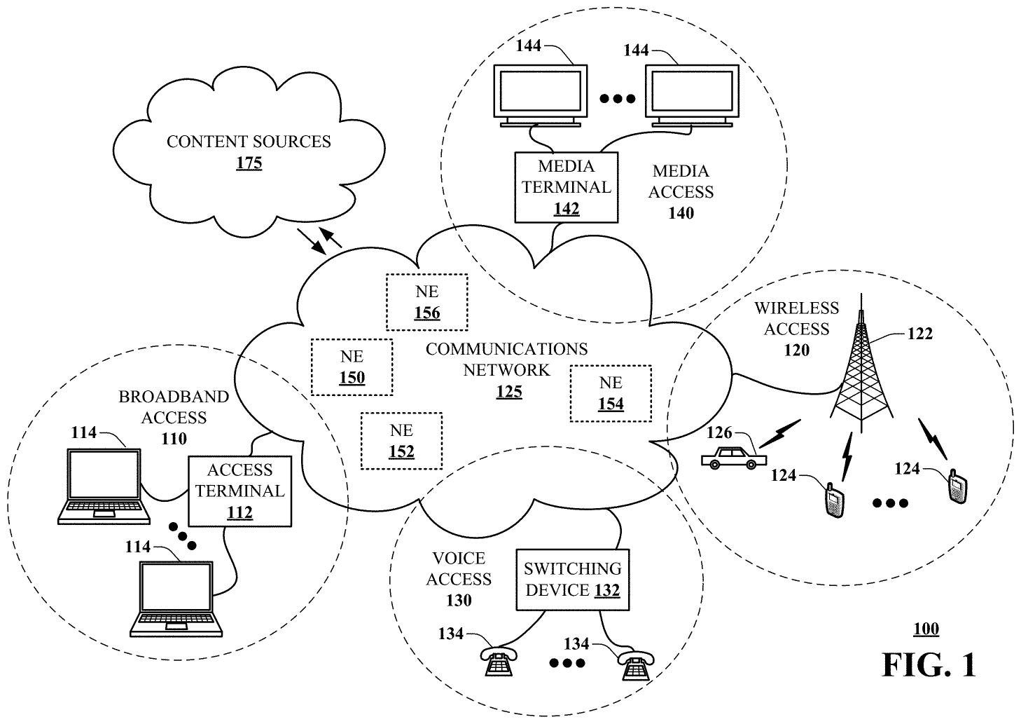

Referring now to FIG. 1, a block diagram is shown illustrating an example, non-limiting embodiment of a system 100 in accordance with various aspects described herein. For example, system 100 can facilitate, in whole or in part, providing a virtual assistant-based product purchasing service. A virtual assistant to a group of members can identify a request for purchase of a product on behalf of a first group member. The virtual assistant can determine other group members having an interest in the product purchase. The virtual assistant can determine characteristics of the product and rank those characteristics for the first group member and the interested group members. The virtual assistant can generate a set of weighted characteristics for the product based on the rankings and apply these weights to a set of product offerings to generate matrix scores. The virtual assistant can determine a ranked list of the product offerings based on the matrix scores. The virtual assistant can compare products of the ranked list with an automatic purchase boundary and, if within the boundary, negotiate a purchase arrangement with a retail virtual assistant. If the products are not within the ranked boundary, the virtual assistant can assess available supply chain information regarding the product and notify the group of purchasing opportunities.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets, or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway, or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

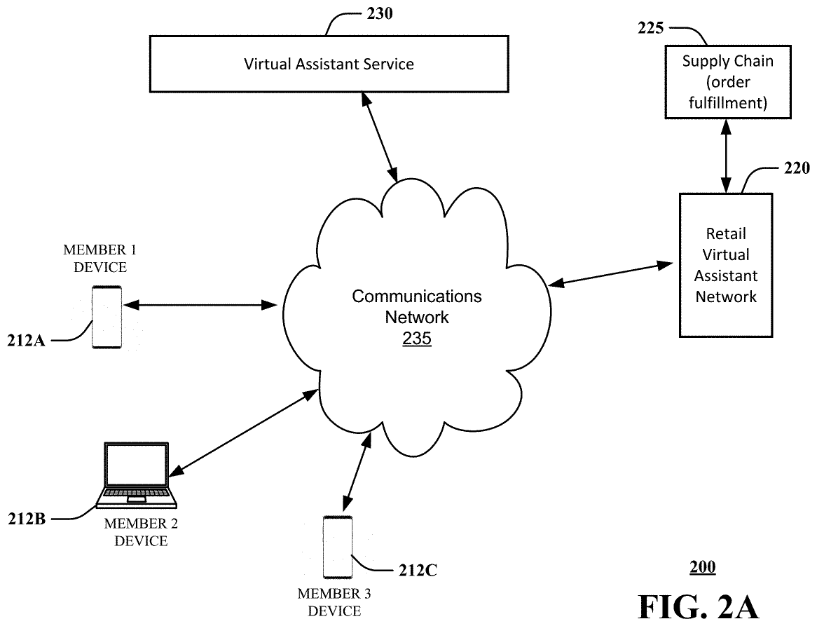

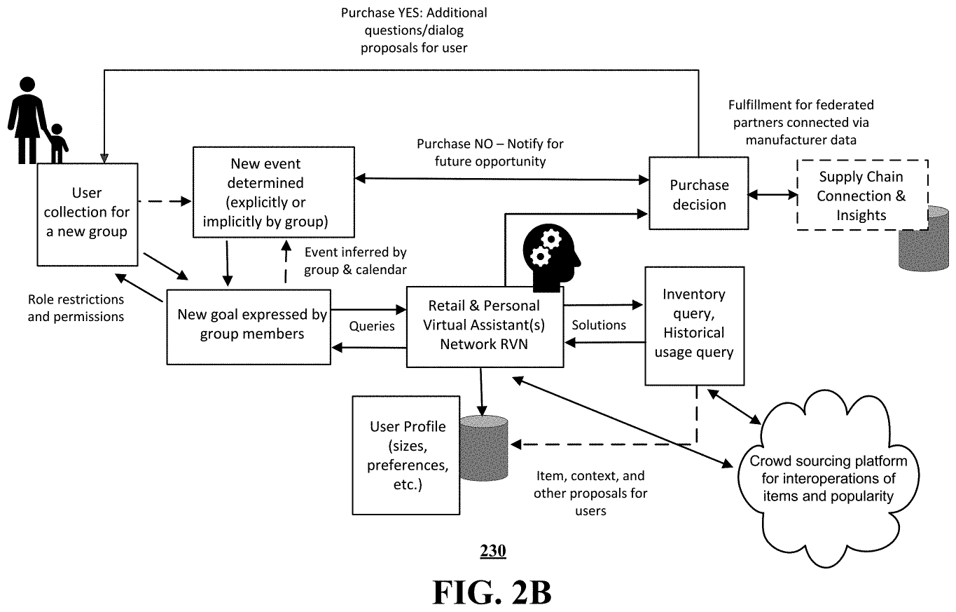

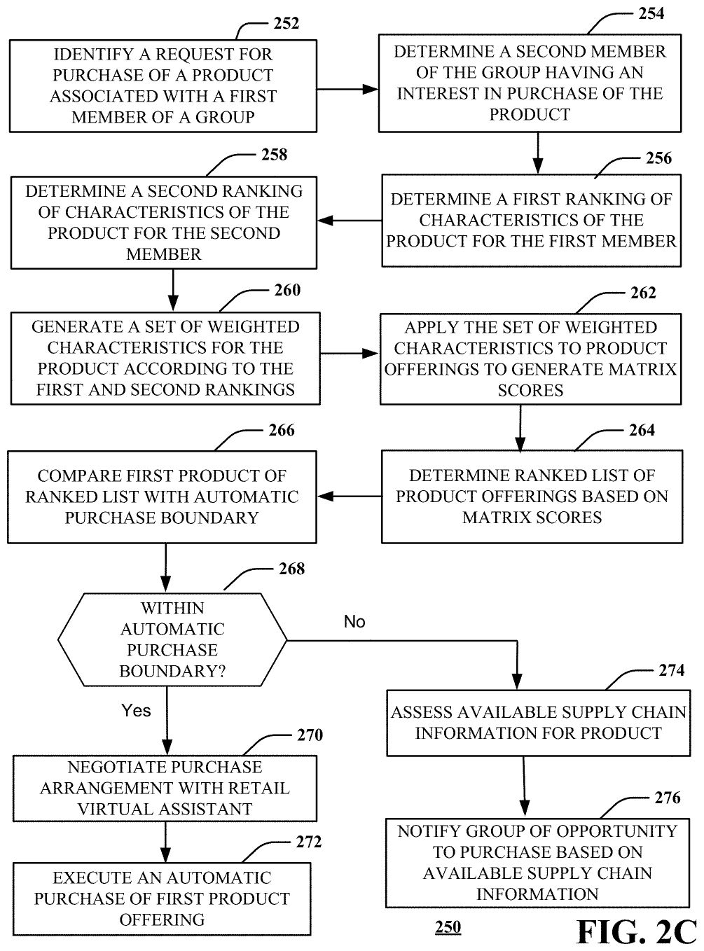

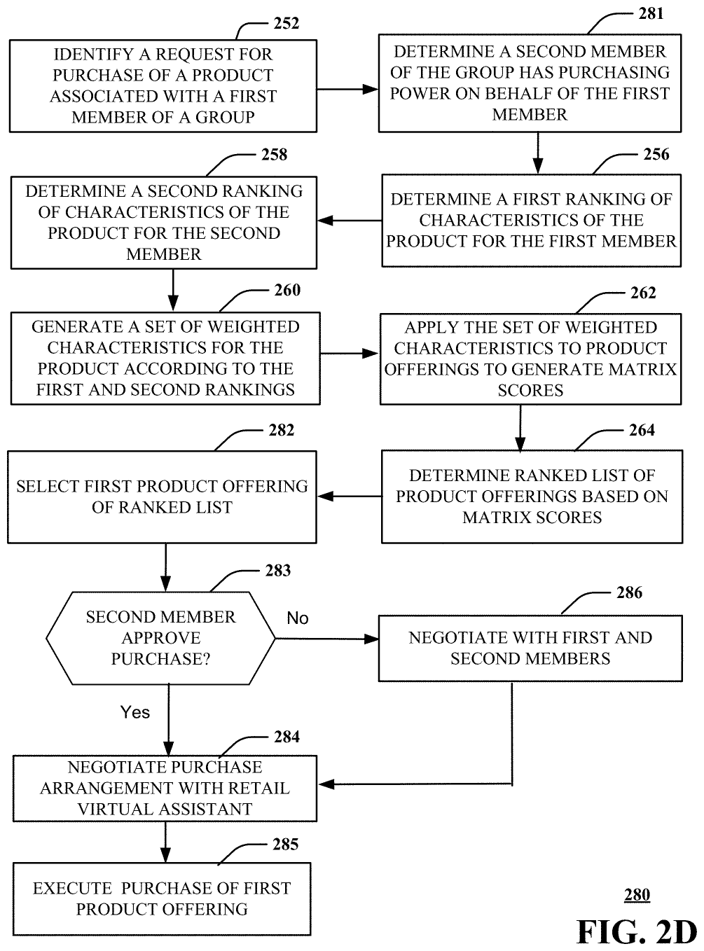

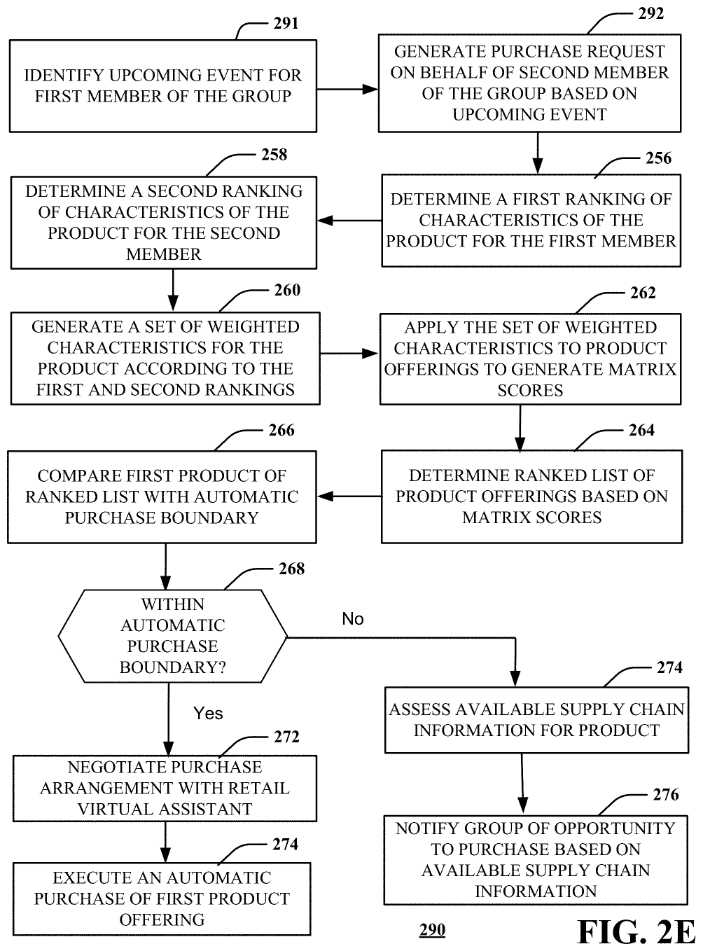

FIG. 2A is a block diagram illustrating an example, non-limiting embodiment of a system 200 functioning within the communication network of FIG. 1 to providing a virtual assistant-based product purchasing service. A virtual assistant to a group of members can identify a request for purchase of a product on behalf of a first group member. The virtual assistant can determine other group members having an interest in the product purchase. The virtual assistant can determine characteristics of the product and rank those characteristics for the first group member and the interested group members. The virtual assistant can generate a set of weighted characteristics for the product based on the rankings and apply these weights to a set of product offerings to generate matrix scores. The virtual assistant can determine a ranked list of the product offerings based on the matrix scores. The virtual assistant can compare products of the ranked list with an automatic purchase boundary and, if within the boundary, negotiate a purchase arrangement with a retail virtual assistant. If the products are not within the ranked boundary, the virtual assistant can assess available supply chain information regarding the product and notify the group of purchasing opportunities.

In one or more embodiments, a system 200 can include a communications network 235 coupled to member devices 212A-C. The member devices 212A-C can belong to a group of people, such as a household or business. This group of people can have the capability of purchasing products or services for use by members of the group. For example, a household or business can include people owning or possessing member devices 212A-C. Multiple people can have capabilities to purchase products. Situations can arise, where particular members have not discussed their individual inputs or preferences with other members. These members might have a specific product in mind or might be open to suggestions about other products if these alternative products meet certain criteria or requirements. If these inputs are not known, then a product might be purchased that fails to meet important criteria of this member or an opportunity to purchase such a product may be missed by the group for lack of proper information. Examples of potential product purchases that are particularly needing of group member input can be a family deciding on a sofa for the family room or a business team deciding on a software package for status updates.

Situations may arise, where there is a need for understanding differences between requirement or “must-haves,” on the one hand, and preferences or other acceptable options, on the other hand. It the system 200 can drive the group of people towards a consensus, based on the correctly assessing these differences in product characteristics, so that a successful product purchase can be effectuated. One example of these differences in with respect to confusion between a product ‘brand’ with actual product requirement (or strong preference). For example, a child member of a family may request a “Batman” Lego™ toy set. However, the child may, in fact, be willing to accept any toy set including the “Batman” character. If this product differentiation can be discovered by a product procurement method of the system 200, then alternative product purchase options can be evaluated and ranked based on differentiating criteria.

In another example, a group member may declare, “I want the latest iPhone™.” However, there is a question as to whether the group member truly requires that the product purchase be an iPhone™, or if what they really want/require is a phone that has certain features/apps. In another scenario, information about the group, such as information about previous purchases, demographics, or location, can reveal an upcoming event of importance to one or more of the group members. This upcoming event can be one for which a purchase, such as a jewelry purchase, would be appropriate or even socially required. It would be useful to the group, or to particular members of the group, to have recommendations and status of availability for products that could be purchased for the event.

In one or more embodiments, a virtual assistant service 230 can communicate with the member devices 212A-C via a communications network 235. The virtual assistant service 230 can determining actual and potential product interests from group members by collecting information from the member devices 212A-C. The virtual assistant service 230 can be an application which the members of the group opt into via their member devices 212A-C. Product interests can be gathered by the virtual assistant service 230 from the member devices 212A-C based on requests for product information from the member devices 212A-C directed to the virtual assistant service 230 or directed to a third-party searching application. The virtual assistant service 230 can determine product interest from prior purchases made by members of the group.

In one or more embodiments, the virtual assistant service 230 can track important dates or events for group members, such as birthdays, anniversaries, or holidays, and can use these events as triggers for gathering product interests from group members having particular attachments to these events. For example, an upcoming birthday can trigger as assessment by the virtual assistant service 230 of product interests for the group members, who is about to celebrate a birthday. For example, the virtual assistant service 230 can request information via this group members' member device 212B in advance of the event. In another example, the virtual assistant 230 can look at product-specific searches, web site visits, or social media interactions by the group member to determine products that may be of interest to this group member. In a similar example, those searches, visits, or interactions can be provided to the virtual assistant via an opt-in data agreement between vendors or retailers on behalf of the user. This event-driven product interest can then be relayed to one or more other group members as a product purchase recommendation for this event via their devices 212A and 212C. These other group members can use this recommendation to select products for purchase on behalf of the celebrating group member. The virtual assistant service 230 can coordinate communications with and between group members to drive agreement on product selections. In one or more embodiments, the virtual assistant service 230 system can prompt and suggest purchase ideas to group members via their member devices 212A-C prior to the event. The virtual assistant service 230 can negotiate and coordinate a suitable purchase for the occasion. The virtual assistant service 230 can independently research, offer options, and negotiate/purchase an appropriate product item based on pre-set criteria.

In one or more embodiments, the virtual assistant service 230 can negotiate and gain consensus among the group members, via their member devices 212A-C, to avoid duplication of purchases and to maximize use of newly obtained products. In additional embodiments, several instances of the virtual assistant service 230 can operate independently on member devices 212A-C and can act as a collective decision-making service or designate a controller service. In either case, a singular consensus can be established for the collective of users and devices. The virtual assistant service 230 can work with and through group members to identify a best fit product purchase for the group. The virtual assistant service 230 can also provide categorically similar items and can add options for ad-ons or other expansion options. For example, where a group member has requested or otherwise shown interest in a “Batman” type of Lego™ toy set, the virtual assistant service 230 can collect and provide to the group members categorically similar products, including other Lego™ toy set, other “Batman” toys, and other toys frequented by similar purchases (e.g., children) in this category). The virtual assistant service 230 can compare features of the requested item with similar items to determine selection options and to prioritize these selection options based on input/characteristics of the group members. For example, the request for the “Batman” type of Lego™ toy set could cause the virtual assistant service to generate a set of product options, which could include a “Batman” action figure. The virtual assistant service 230 can compare characteristics to the “Batman” action figure and other product options to the “Batman” type of Lego™ toy set and prioritize these optional selections based on knowledge characteristics that are of particular importance to the group and, more specifically, to the requesting member of the group. The virtual assistant service 230 can compare usefulness/desirability of features and the specific characteristics of various product alternatives to maximize the usefulness/desirability of a particular product item recommendation for this specific group and/or for a specific member of the group.

In one or more embodiments, the virtual assistant service 230 can communicate with one or more retail virtual assistants 220 via the communications network 235. The virtual assistant service 230 interacts with a retail virtual network of one or more retail virtual assistants that represent a shopping goal and group with a local retail store, a retail network, or a supply chain 225 for a larger set of retail products. The virtual assistant service 230 can interact with the retail virtual network in dialog and/or quiet interactions that align with to a shopping goal as agreed upon by the group. The virtual assistant service 230 can solicit opinions and give feedback between the virtual assistant service 230 and the retail virtual network 220 via a semi-interactive or fully automated mode based on if preferences in the virtual assistant service 230. In one or more embodiments, the retain virtual network 220 can communicate with the supply chain 225 for fulfillment and/or supply based on the shopping goal. The retail virtual network 220 can negotiate with other backend retail virtual networks 220 and/or other virtual assistant services 230, such as a second virtual service 230 associated with the group members, to prevent duplicate purchasing of either historical purchases or planned purchases.

FIG. 2B is a workflow diagram illustrating an example, non-limiting embodiment of a system functioning within the communication network of FIG. 1 to providing a virtual assistant-based product purchasing service. A virtual assistant service 230 to a group of members can identify a request for purchase of a product on behalf of a first group member. The virtual assistant service 230 can determine other group members having an interest in the product purchase. The virtual assistant can determine characteristics of the product and rank those characteristics for the first group member and the interested group members. The virtual assistant service 230 can generate a set of weighted characteristics for the product based on the rankings and apply these weights to a set of product offerings to generate matrix scores. The virtual assistant service 230 can determine a ranked list of the product offerings based on the matrix scores. The virtual assistant service 230 can compare products of the ranked list with an automatic purchase boundary and, if within the boundary, negotiate a purchase arrangement with a retail virtual assistant. If the products are not within the ranked boundary, the virtual assistant service 230 can assess available supply chain information regarding the product and notify the group of purchasing opportunities.

The virtual assistant service 230 goes beyond existing methods for discovery and application of price-aware operations. For example, coupon finding methods may discover a product name from a website or social media contribution and search for posted coupons or vendors of that product. By comparison, the ascribed virtual assistant service 230 can go beyond this implementation in two critical ways. First, the virtual assistant service 230 can proactively search the requirements among multiple users (instead of specifically at purchase time). Second, the virtual assistant service 230 can expand the search for matching products beyond a specific instance or brand that may be specified with one shopping session or pre-determined wish-list. In another embodiment, where coupon discovery services may be utilized, the virtual assistant service 230 can include a more complex weighting and prioritization of potential product purchases.

In one or more embodiments, the virtual assistant service 230 can also engage in interactive or multi-turn negotiations with an automated retail assistant network 220. In one embodiment, a retail assistant network 220 may offer one or more purchase opportunities to the retail assistant service 230. One common example is the choice between options to pay a higher price up front but get the product sooner or utilize a payment structure but receive a degraded or delayed product. Another example is the choice between one or more supply chain vendors 225, where the product may be slightly used, of a slightly different brand (e.g., through another white-boxed or OEM vendor), or the bundling of multiple products or multiple non-tangible extras, like warranties. In one embodiment, the virtual assistant service 230 can receive all of these choices and prioritize them based on historical purchases of the group of users. In another embodiment, the virtual assistant service 230 can create multiple counteroffers with additional choices for the retail virtual assistant network 220, such as faster payment, forfeiture of warranty, or a guarantee for additional purchases at a future time from the same vendor (e.g., the virtual assistant service 230 may know that multiple products from the same vendor are in the desired purchase goals). In yet another embodiment, the counter-offer process may be fully automated, semi-automated (e.g., visibility to the users), or proxied by specific user acknowledgement and acceptance. This information can be used in ranking/prioritizing different available products or versions of products. In one or more embodiments, the virtual assistant service 230 can separate “brand” from “type of product” and offer both options to a user based on parameters, such as age, context, profile, preferences, current specification, and/or user-specific historical information. In addition, the virtual assistant service 230 can negotiate with a seller, circle back with the user for confirmation and/or changes in boundaries, and/or purchase the product within the specified boundaries.

In one or more embodiments, virtual assistant service 230 can collect and maintain a group profile with user information associated with member of the group. The group profile can include information member devices and member role restrictions and permissions, such as which member require permission to make purchases (e.g., minor children or junior level employees) and which members must give permission for these purchases (e.g., parents or managing employees). The virtual assistant service 230 gather information about a new purchasing goal as expressed by one of the group members. Alternatively, a new purchasing goal may be triggered by a new event (e.g., a birthday) such that the requested goal is implicitly determined based on the event. The virtual assistant service 230 can query one or more retail virtual networks or one or more other virtual assistant services to develop a set of products that potentially meet the requirements of the product goal. The virtual assistant service 230 can query available inventory to determine product availability, features, and costs. The virtual assistant service 230 can query historical usage information to determine what similar (or identical) products have been purchased by the group in the past. The virtual assistant service 230 can include the historic purchasing information in a user profile database for the group members, with important categorical information, such as product sizes, preferences, dislikes, and so forth. The virtual assistant service 230 can access social media platforms to crowd source information about product reviews, interoperability of products, and popularity.

In one or more embodiments, the virtual assistant service 230 can determine if an available product will be purchased. For example, the virtual assistant service 230 can determine that Product X is the top ranked product that meets the purchasing goal of the group based on features, cost, and ranking, and that this product is immediately available for purchase from the supply change according to the retail virtual network. Following negotiation with the retail virtual network, the virtual assistant service 230 can compare the agreed upon purchase price to a maximum automatic purchase cost that is included in the group profile information. If the price does not exceed the maximum automatic purchase limit, then the virtual assistant service 230 can proceed to purchase product on behalf of the group without further interaction with the group members. However, if the product price exceeds the maximum automatic purchase limit, then the virtual assistant service 230 can notify the group (excepting the event celebrant) of the opportunity to purchase and of any future opportunities to purchase this product item as they arise. The virtual assistant service 230 can engage in additional communications with the group members, via their member devices 212A-C, to determine if the group members wish to exceed the automatic purchase limit or if the members which to select a different product or to modify the product goal or its features. If the group members approve overriding the automatic purchase limit, for example, the virtual assistant service 230 can complete the purchase, which can be fulfilled by the supply chain.

In one or more embodiments, the virtual assistant service 230 can facilitate driving the group members towards a “consensus” by listing and weighting key features of each product in list of proposed products that meet the goal established by the product request. For example, if the product request is for a bicycle, then the virtual assistant service 230 can consult with one or more retail virtual assistants to develop a list of bicycles that fit this goal. The virtual assistant service 230 can then features of each bicycle to a set of key features—requirements and preferences—that is developed from the group members. For example, the requesting group member may provide a set of features along with the request for the bicycle. Other group members can be asked to provide their list of key features or to indicate their agreement or disagreement with the list provided by the requesting member. The virtual assistant service 230 can analyze past purchases for additional insight into features the group members found important or unimportant. The virtual assistant service 230 can then weight the key features provided or developed from the group members against the known features of each of the bicycles in the proposed list. Each bicycle can be scored by weighting each of its features against the relative rankings of those features derived from the members of the group. For example, the group may rank a certain handlebar configuration as a top priority but not prioritize the number of speed configurations. The virtual assistant service 230 can turn these priorities into relative weights and then multiple the features of each proposed bicycle by these weights. A resulting “score” can be derived by the virtual assistant service 230 for each bicycle such that a matrix of scores can be generated for the entire list of bicycles. The virtual assistant service 230 can then rank the set of proposed bicycles according to the matrix of scores and provide the ranked list to the group.

In one or more embodiments, the virtual assistant service 230 can track and analyze purchase history for the group members. The virtual assistant service 230 can determine what products have been purchased before. The virtual assistant service 230 can query the members of the group via their member devices 212A-C for information on product usage and product needs/trends. This information can allow the virtual assistant service 230 to determine which items have been used the most and/or which items are desired or needed. The virtual assistant service 230 can pool purchase histories and member intentions across multiple purchasers. For example, the virtual assistant service 230 can track how potential products solve the larger goal/theme that is requested by the group rather without requiring the group members to pre-specify exactly what is of interest.

In one or more embodiments, the virtual assistant service 230 can differentiate between a specific item, such as a specific brand with a standard set of features and an alternative with high level of matching features. The virtual assistant service 230 can increase the likelihood that alternative products will be accepted by group members. The virtual assistant service 230 can use information from retail virtual assistants to detect product trends in the marketplace before the group members are aware of these trends. The virtual assistant service 230 can notify the group of these trends, before the supply chain sells out of inventory. For example, the virtual assistant service 230 can use historical purchasing analysis to determine that a group member is likely to require a product purchase for an upcoming Father's Day. The virtual assistant service 230 can obtain trend information from a retail virtual assistant to gain visibility into the fastest selling items and combine the Father's Day event information with the trend information to trigger a notification to the group member regarding purchase of a trending product before supplies run out and/or recommendations for alternative products.

FIGS. 2C-2E depict illustrative embodiments of methods in accordance with various aspects described herein. Referring now to FIG. 2C, an illustrative embodiment of method 250 is illustrated. In one or more embodiments, in the method 250, at step 252, the virtual assistant service 230 can identify a request for purchase of a product associated with a first member of a group. The request for purchase can be a goal request, where a particular product is not directly specified. The goal request can be made through the virtual assistant service 230 or through a “borrowed” virtual assistant, such as a retail virtual assistant. The request for purchase can be indirect, where the virtual assistant service 230 determines an interest in a product goal by the group or by a member of the group based on information captured by a member device. For example, a member can visit a website associated with a product or can enter a comment or like a social media post associated with a product. The virtual assistant service 230 can interpret these actions as indicative of an interest in the product as a goal.

At step 254, the virtual assistant service 230 can determine if a second member (or additional members) of the group has an interest the product goal. For example, the virtual assistant service 230 can query the other members of the group and/or the history of the group for related previous searches. The interested member or members can be a subset of the total group, based on gauged interested on the topic or based on relevance of the purchase goal on the individual members. At steps 256 and 258, the virtual assistant service 230 can determine rankings of preferences and characteristics for the product for the first member and for the second member. The preferences and characteristics can be based on requirements and/or desired features. At step 260, the virtual assistant service 230 can generate a set of weighted characteristics for the product based on the rankings of characteristics for the first and second members. At step 262, the virtual assistant service 230 can apply the set of weighted characteristics to a set of product offerings to generate matrix scores.

At step 264, the virtual assistant service 230 can determine a ranked list of product offerings based on the matrix scores. At step 266, the virtual assistant service 230 can compare a first product of the ranked list with an automatic purchase boundary. If the purchase price of the first product is within the automatic purchase boundary at step 268, then the virtual assistant service 230 can negotiate a purchase arrangement with a retail virtual assistant at step 270. At step 272, the virtual assistant service 230 can execute an automatic purchase of the first product offering. If the purchase price of the first product is not within the automatic purchase boundary, at step 268, then the virtual assistant service 230 can assess the available supply chain, at step 274. At step 276, the virtual assistant service 230 can notify the group of an opportunity to purchase the product based on available supply chain information. The virtual assistant service 230 can present recommendation to the group for user consideration. The virtual assistant service 230 can negotiate between group members to reach consensus. In one or more embodiments, the virtual assistant service 230 can gather other user demand via explicit data, such as market demand analysis or trend analysis, or based on assumed trends, such as gift grouping by time of year or event. The virtual assistant service 230 can calculate supply chain against current demand and notify group members when purchase should be made to avoid missing out.

Referring now to FIG. 2D, an illustrative embodiment of method 280 is illustrated. In one or more embodiments, in the method 280, at step 252, the virtual assistant service 230 can identify a request for purchase of a product associated with a first member of a group. At step 281, the virtual assistant service 230 can determine if a second member (or additional members) of the group has purchasing power on behalf of the first member of the group. For example, the first member can be determined to be a child without explicit purchase power, while the first member can be determined to be a parent or guardian with purchasing authority over the first member. Limitations can be placed over the first member. The request for purchase can be a goal request, where a particular product is not directly specified. The goal request can be made through the virtual assistant service 230 or through a “borrowed” virtual assistant, such as a retail virtual assistant. The request for purchase can be indirect, where the virtual assistant service 230 determines an interest in a product goal by the group or by a member of the group based on information captured by a member device. For example, a member can visit a website associated with a product or can enter a comment or like a social media post associated with a product. The virtual assistant service 230 can interpret these actions as indicative of an interest in the product as a goal.

At steps 256 and 258, the virtual assistant service 230 can determine rankings of preferences and characteristics for the product for the first member and for the second member. The preferences and characteristics can be based on requirements and/or desired features. At step 260, the virtual assistant service 230 can generate a set of weighted characteristics for the product based on the rankings of characteristics for the first and second members. At step 262, the virtual assistant service 230 can apply the set of weighted characteristics to a set of product offerings to generate matrix scores.

At step 264, the virtual assistant service 230 can determine a ranked list of product offerings based on the matrix scores. At step 282 the virtual assistant service 230 can receive a selection of a first product of the ranked list. At step 283, the virtual assistant service 230 can determine whether the second member has approved the purchase of the first product. If the second member does approve the purchase, then, at step 284, the virtual assistant service 230 can negotiate a purchase arrangement with a retail virtual assistant at step 284. At step 285, the virtual assistant service 230 can execute an automatic purchase of the first product offering. If the second member does not approve of the purchase, at step 283, then, at step 286, the virtual assistant service 230 can negotiate between the first and second group members to reach consensus.

Referring now to FIG. 2E, an illustrative embodiment of method 290 is illustrated. In one or more embodiments, in the method 290, at step 291, the virtual assistant service 230 can identify an upcoming event associated with a first member of the group, at step 291. For example, the virtual assistant service 230 can maintain a database of birthdays, anniversaries, and/or holidays that correspond to gift giving and other product purchasing opportunities. The event can create a product buying opportunity for the first member of the group on behalf of the second member of the group. Alternatively, the buying opportunity can be on behalf of a non-member of the group. At step 292, the virtual assistant service 230 can generate a request for purchase of a product on behalf of the second member of a group. The request for purchase can be a goal request, where a particular product is not directly specified. The goal request can be made through the virtual assistant service 230 or through a “borrowed” virtual assistant, such as a retail virtual assistant. The request for purchase can be indirect, where the virtual assistant service 230 determines an interest in a product goal by the group or by a member of the group based on information captured by a member device. For example, a member can visit a website associated with a product or can enter a comment or like a social media post associated with a product. The virtual assistant service 230 can interpret these actions as indicative of an interest in the product as a goal. To maintain discreteness and surprise, the virtual assistant service 230 can query the intended recipient well in advance of the event date.

At steps 256 and 258, the virtual assistant service 230 can determine rankings of preferences and characteristics for the product for the first member and for the second member. The preferences and characteristics can be based on requirements and/or desired features. At step 260, the virtual assistant service 230 can generate a set of weighted characteristics for the product based on the rankings of characteristics for the first and second members. At step 262, the virtual assistant service 230 can apply the set of weighted characteristics to a set of product offerings to generate matrix scores.

At step 264, the virtual assistant service 230 can determine a ranked list of product offerings based on the matrix scores. At step 266, the virtual assistant service 230 can compare a first product of the ranked list with an automatic purchase boundary. If the purchase price of the first product is within the automatic purchase boundary at step 268, then the virtual assistant service 230 can negotiate a purchase arrangement with a retail virtual assistant at step 270. At step 272, the virtual assistant service 230 can execute an automatic purchase of the first product offering. If the purchase price of the first product is not within the automatic purchase boundary, at step 268, then the virtual assistant service 230 can assess the available supply chain, at step 274. At step 276, the virtual assistant service 230 can notify the group of an opportunity to purchase the product based on available supply chain information. The virtual assistant service 230 can present recommendation to the group for user consideration. The virtual assistant service 230 can negotiate between group members to reach consensus. In one or more embodiments, the virtual assistant service 230 can gather other user demand via explicit data, such as market demand analysis or trend analysis, or based on assumed trends, such as gift grouping by time of year or event. The virtual assistant service 230 can calculate supply chain against current demand and notify group members when purchase should be made to avoid missing out.

While for purposes of simplicity of explanation, the respective processes are shown and described as a series of blocks in FIGS. 2C-2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, the system 200 can provide a new goal-based shopping model featuring a virtual assistant service 230 associated with a retail virtual assistant network 220. By defining a purchasing goal instead of specific item, the system 200 provides flexibility to allow the virtual assistant service 230 to match options from the retail virtual assistant network 220 and the needs and preferences of the purchasing group or group member. The system 200 facilitates novel dialoging between the virtual assistant service 230 and the retail virtual assistant network 220 to allow both interactive and non-interactive queries, such as pulling from user profile and/or past requests and/or supply chain requests for inventory. The system 200 facilitates definition of a shopping/commerce group and the organic discovery of specific items to fulfill purchasing goals of this group.

In one or more embodiments, a purchasing goal can be explicit, such as purchasing toys for kids at charity, or implied, such purchases for typical gift giving during an anniversary for others in a similar group. The system 200 can access historical shopping information, including item receipts, and can further infer preferences between item types and categories. The system 200 can discover and map alternate purchase items based on profile and external data. The retail virtual assistant network 220 may explore new product creation modes acting as an intermediary for crowd-sourced demands. For example, the retail virtual assistant network 220 can solicitate options to be presented to user for potential undeveloped products. The retail virtual assistant network 220 can explore external knowledge source, such as pairings, do it yourself material, and/or crafting sites, to expand solutions for a goal.

In one or more embodiments, the system 200 can facilitate ranking and prioritization among availability and perceived intent, weighting is performed against profile and capability (e.g., cost, implications) for each member of the commerce group. The ranking, prioritizing, and weighting can allow the system 200 to prioritize item purchases among entire group. The system 200 can provide a direct connection between the virtual assistant service 230 and the supply chain 225 (at multiple points) via the retail virtual assistant network 220. The retail virtual assistant network 220 can search for best available fulfillment options and prioritize these options based on supply and demand. The retail virtual assistant network 220 can incentivize and upsell to group members via the virtual assistant service 230. The system can discover item popularity and supply and demand for each new shopping goal/group. This information can enhance supply chain planning in the retail virtual assistant network 220.

In one or more embodiments, the system 200 can provide several benefits. A unified commerce target can be directed to a generic item, which facilitates more flexible shopping than targeting a specific item, in terms of both costs and user satisfaction/engagement. A unified group shopping experience targeting a purchasing goal can provide a better commerce experience, where every member can contribute to a group/goal without having to explicitly coordinate or ask other members. For example, the goal can focus on simplifying shopping goals during holiday or on fulfilling a general “taste” for a product, where the prospective recipient in the group has generic shopping preferences for brand/product but fails to explicitly communicate this with the group. The system 200 can identify shopping items using external media and sources of information. The system 200 can expand the shopping search to general solutions that go beyond an explicit item number or class. The operations of both the supply chain 225 (selling remaining items) and the purchasing group (finding acceptable solutions) are enhanced. Businesses gain greater visibility to customer demands and an ability to right size desired quantities to purchasing groups. The use of crowdsourcing can provide more revenue generating opportunities and are more useful than survey-based methods.

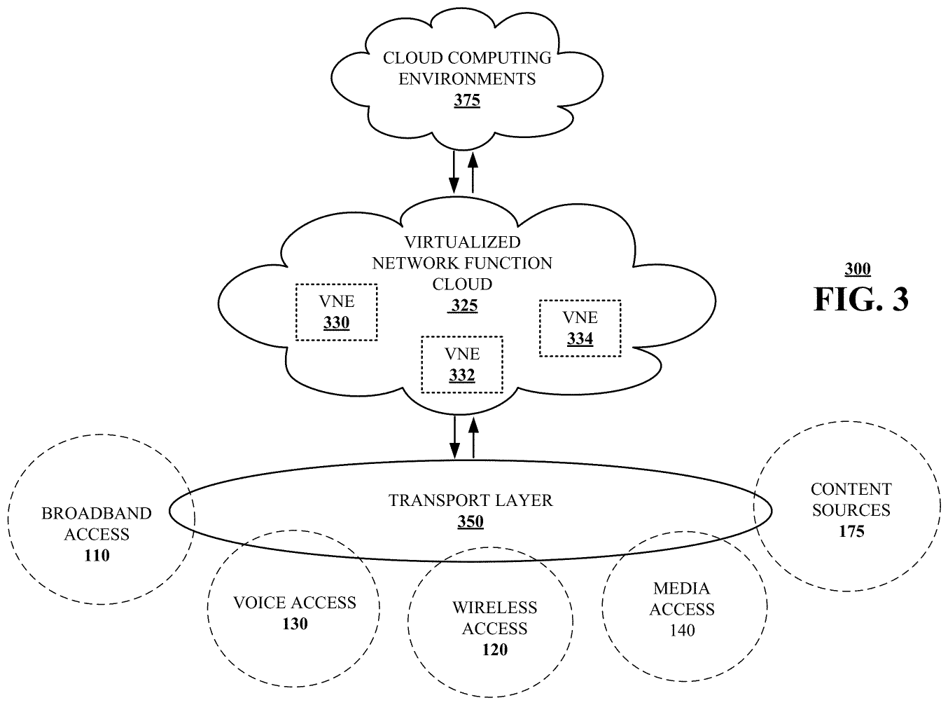

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, 2D, 2E, and 3. For example, virtualized communication network 300 can facilitate, in whole or in part, providing a virtual assistant-based product purchasing service. A virtual assistant to a group of members can identify a request for purchase of a product on behalf of a first group member. The virtual assistant can determine other group members having an interest in the product purchase. The virtual assistant can determine characteristics of the product and rank those characteristics for the first group member and the interested group members. The virtual assistant can generate a set of weighted characteristics for the product based on the rankings and apply these weights to a set of product offerings to generate matrix scores. The virtual assistant can determine a ranked list of the product offerings based on the matrix scores. The virtual assistant can compare products of the ranked list with an automatic purchase boundary and, if within the boundary, negotiate a purchase arrangement with a retail virtual assistant. If the products are not within the ranked boundary, the virtual assistant can assess available supply chain information regarding the product and notify the group of purchasing opportunities.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic and the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers, and other network elements. Because these elements don't typically need to forward large amounts of traffic, their workload can be distributed across a number of servers—each of which adds a portion of the capability, and overall, which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

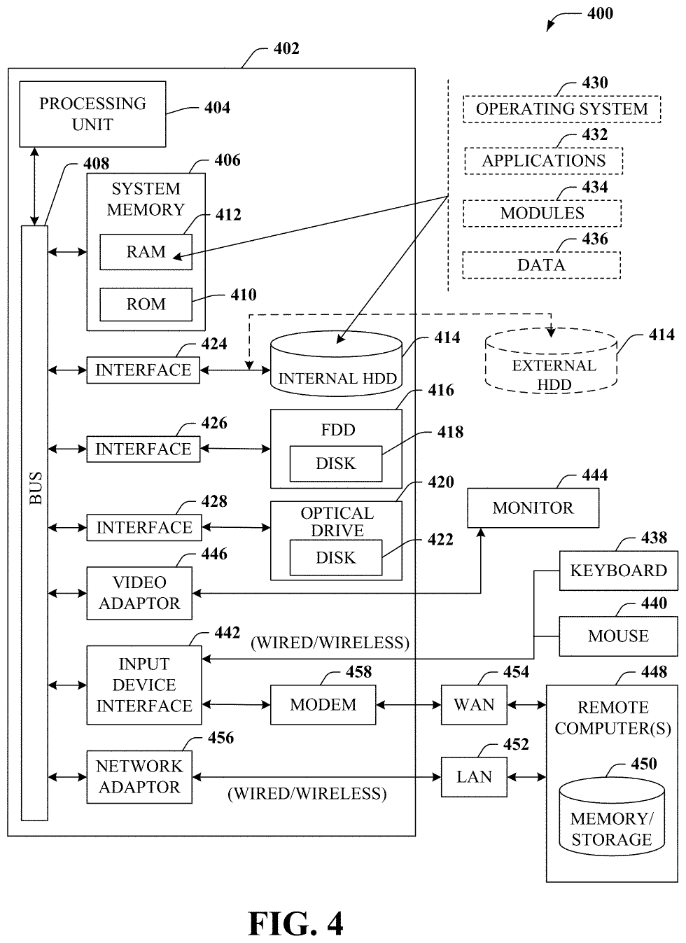

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, providing a virtual assistant-based product purchasing service. A virtual assistant to a group of members can identify a request for purchase of a product on behalf of a first group member. The virtual assistant can determine other group members having an interest in the product purchase. The virtual assistant can determine characteristics of the product and rank those characteristics for the first group member and the interested group members. The virtual assistant can generate a set of weighted characteristics for the product based on the rankings and apply these weights to a set of product offerings to generate matrix scores. The virtual assistant can determine a ranked list of the product offerings based on the matrix scores. The virtual assistant can compare products of the ranked list with an automatic purchase boundary and, if within the boundary, negotiate a purchase arrangement with a retail virtual assistant. If the products are not within the ranked boundary, the virtual assistant can assess available supply chain information regarding the product and notify the group of purchasing opportunities.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared, and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

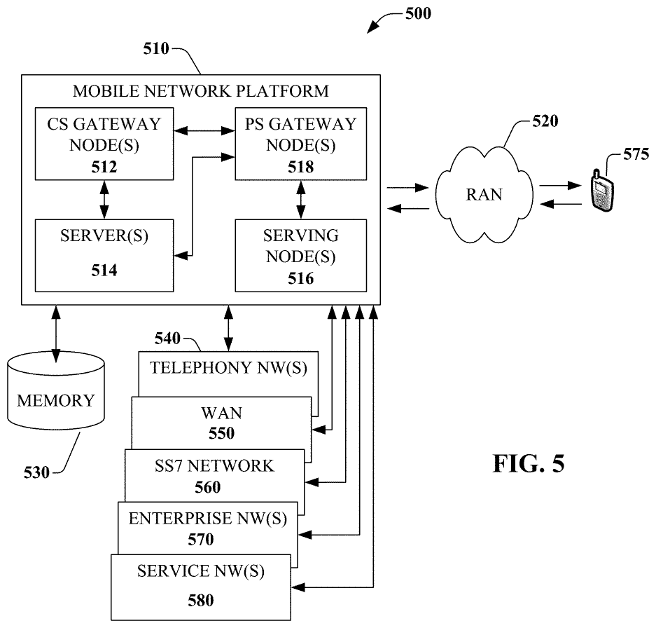

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, providing a virtual assistant-based product purchasing service. A virtual assistant to a group of members can identify a request for purchase of a product on behalf of a first group member. The virtual assistant can determine other group members having an interest in the product purchase. The virtual assistant can determine characteristics of the product and rank those characteristics for the first group member and the interested group members. The virtual assistant can generate a set of weighted characteristics for the product based on the rankings and apply these weights to a set of product offerings to generate matrix scores. The virtual assistant can determine a ranked list of the product offerings based on the matrix scores. The virtual assistant can compare products of the ranked list with an automatic purchase boundary and, if within the boundary, negotiate a purchase arrangement with a retail virtual assistant. If the products are not within the ranked boundary, the virtual assistant can assess available supply chain information regarding the product and notify the group of purchasing opportunities.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

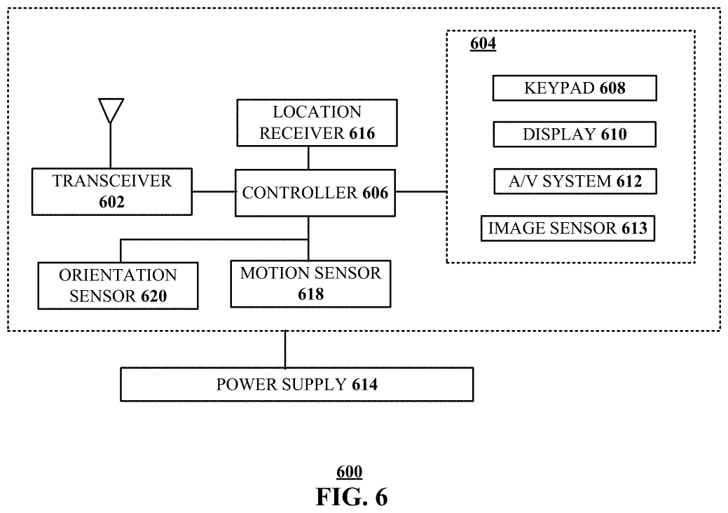

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communication network 125. For example, computing device 600 can facilitate, in whole or in part, providing a virtual assistant-based product purchasing service. A virtual assistant to a group of members can identify a request for purchase of a product on behalf of a first group member. The virtual assistant can determine other group members having an interest in the product purchase. The virtual assistant can determine characteristics of the product and rank those characteristics for the first group member and the interested group members. The virtual assistant can generate a set of weighted characteristics for the product based on the rankings and apply these weights to a set of product offerings to generate matrix scores. The virtual assistant can determine a ranked list of the product offerings based on the matrix scores. The virtual assistant can compare products of the ranked list with an automatic purchase boundary and, if within the boundary, negotiate a purchase arrangement with a retail virtual assistant. If the products are not within the ranked boundary, the virtual assistant can assess available supply chain information regarding the product and notify the group of purchasing opportunities.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive, or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM, or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches, and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature, or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
identifying, by a processing system including a processor, a request for a purchase of a product associated with a first member of a group, wherein a second member of the group has an interest in the purchase of the product;
determining, by the processing system, a first ranking of characteristics associated with the product for the first member of the group and a second ranking of the characteristics associated with the product for the second member of the group;
applying, by the processing system, a set of weighted characteristics to a plurality of product offerings for fulfilling the request to purchase the product based on the first ranking of the characteristics and the second ranking of the characteristics to generate a plurality of matrix scores associated with the plurality of product offerings;
determining, by the processing system, a ranked list of the plurality of product offerings for the fulfilling the request to purchase the product according to the plurality of matrix scores associated with the plurality of product offerings and according to historical purchasing data associated with the group;
determining, by the processing system, if a first product offering of the ranked list of the plurality of product offerings falls within an automatic purchase boundary according to a purchasing profile associated with the group;
negotiating, by the processing system, with a retail virtual assistant, a purchase arrangement associated with the first product offering of the ranked list of the plurality of product offerings responsive to the determining the first product offering falls within the automatic purchase boundary; and
executing, by the processing system, an automatic purchase of the first product offering of the ranked list of the plurality of product offerings according to the purchase arrangement.

2. The method of claim 1, further comprising generating, by the processing system, the set of weighted characteristics associated with the product according to the first ranking of the characteristics and the second ranking of the characteristics associated with the product.

3. The method of claim 1, further comprising negotiating, by the processing system, a purchasing decision between the first member and the second member of the group according to the ranked list of the plurality of product offerings.

4. The method of claim 3, further comprising presenting, by the processing system, a recommendation for purchase of a second product offering of the ranked list of the plurality of product offerings.

5. The method of claim 1, wherein the identifying the request for the purchase of the product further comprises determining, by the processing system, product interest associated with the first member of the group by analyzing search information associated with the first member.

6. The method of claim 1, wherein the identifying the request for the purchase of the product further comprises identifying, by the processing system, an upcoming event associated with the first member of the group.

7. The method of claim 6, further comprising querying, by the processing system, the second member of the group regarding the upcoming event associated with the first member of the group.

8. The method of claim 1, wherein the identifying the request for the purchase of the product further comprises generating, by the processing system, a recommendation according to a prior purchase associated with the first member of the group.

9. The method of claim 1, wherein the determining the second member of the group having an interest in the purchase of the product further comprises querying, by the processing system, the second member of the group, analyzing, by the processing system, search information associated with the second member, or any combination thereof.

10. The method of claim 1, further comprising determining, by the processing system, if the second member of the group has purchasing power on behalf of the first member, wherein purchasing power of the first member of the group is limited.

11. The method of claim 10, further comprising:
determining, by the processing system, the second member of the group does not approve the purchase of the product; and
negotiating, by the processing system, a purchasing decision with the second member of the group responsive to determining the second member of the group does not approve the purchase of the product.

12. The method of claim 1, notifying, by the processing system, the group of an opportunity to purchase the product according to available supply chain information responsive to the determining the first product offering does not fall within the automatic purchase boundary.

13. The method of claim 12, further comprising:
gathering, by the processing system, product demand information associated with the group; and
determining, by the processing system, the available supply chain information according to the product demand information.

14. A device, comprising:
a processing system including a processor; and
a memory that stores executable instructions that, when executed by the processing system, facilitate performance of operations, the operations comprising:
identifying a request for a purchase of a product associated with a first member of a group;
determining a second member of the group having an interest in the purchase of the product;
determining a first ranking of characteristics associated with the product for the first member of the group and a second ranking of the characteristics associated with the product for the second member of the group;
generating a set of weighted characteristics associated with the product according to the first ranking of the characteristics and the second ranking of the characteristics associated with the product;
applying the set of weighted characteristics to a plurality of product offerings for fulfilling the request to purchase the product to generate a plurality of matrix scores associated with the plurality of product offerings;
determining a ranked list of the plurality of product offerings for the fulfilling the request to purchase the product according to the plurality of matrix scores associated with the plurality of product offerings;
negotiating, with a retail virtual assistant, a purchase arrangement associated with a first product offering of the ranked list of the plurality of product offerings; and
executing the purchase arrangement of the first product offering of the ranked list of the plurality of product offerings.

15. The device of claim 14, wherein the operations further comprise determining if a first product offering of the ranked list of the plurality of product offerings falls within an automatic purchase boundary according to a purchasing profile associated with the group.

16. The device of claim 14, wherein the operations further comprise negotiating a purchasing decision between the first member and the second member of the group according to the ranked list of the plurality of product offerings.

17. The device of claim 14, wherein the operations further comprise
determining the second member of the group does not approve the purchase of the product, wherein the second member of the group has purchasing power on behalf of the first member; and
negotiating a purchasing decision with the second member of the group responsive to determining the second member of the group does not approve the purchase of the product.

18. The device of claim 14, wherein the operations further comprise:
gathering product demand information associated with the group;
determining available supply chain information according to the product demand information; and
notifying the group of an opportunity to purchase the product according to available supply chain information.

19. A non-transitory machine-readable medium, comprising executable instructions that, when executed by a processing system including a processor, facilitate performance of operations, the operations comprising:
identifying an upcoming event associated with a first member of a group, wherein the upcoming event is associated with an interest, by a second member of the group, in a purchase of a product associated with the first member of the group;
generating a set of weighted characteristics associated with the product according to a first ranking of characteristics associated with the product and the first member and a second ranking of the characteristics associated with the product and the second member;
applying the set of weighted characteristics to a plurality of product offerings for fulfilling the request to purchase the product to generate a plurality of matrix scores associated with the plurality of product offerings;
determining a ranked list of the plurality of product offerings for the fulfilling the request to purchase the product according to the plurality of matrix scores associated with the plurality of product offerings;
negotiating, with a retail virtual assistant, a purchase arrangement associated with a first product offering of the ranked list of the plurality of product offerings; and
executing an automatic purchase of the first product offering of the ranked list of the plurality of product offerings according to the purchase arrangement.

20. The non-transitory machine-readable medium of claim 19, wherein the operations further comprise determining if a first product offering of the ranked list of the plurality of product offerings falls within an automatic purchase boundary according to a purchasing profile associated with the group.
